(19) United States
(12) Patent Application Publication
(10) Pub. No.: US 2026/0110071 A1
(43) Pub. Date: Apr. 23, 2026

(54) METHOD FOR PROCESSING METAL ARTICLES

(71) Applicant: General Electric Company, Evendale, OH (US)

(72) Inventors: Laura Cerully Dial, Arden, NC (US); Chen Shen, Schenectady, NY (US); Timothy Hanlon, Glenmont, NY (US)

(21) Appl. No.: 18/914,407

(22) Filed: Oct. 14, 2024

(51) Int. Cl. C22F 1/10; B33Y 40/20; B33Y 80/00; C22C 19/05

(52) U.S. Cl. CPC C22F 1/10; B33Y 40/20; B33Y 80/00; C22C 19/055; C22C 19/058

(57) ABSTRACT

A method for processing a metal article includes pressure heating the metal article at a first temperature that is below a solvus temperature of a precipitate to reduce growth of surface variation of an outer surface of the metal article and heating the metal article at a second temperature that is above the solvus temperature of the precipitate to form a recrystallized grain structure of the metal article.

### FIELD

The present disclosure relates to processing of metal articles, particularly processing of articles formed from superalloys with heat.

### BACKGROUND

Ni-based superalloys are a useful family of alloys that can be designed to be used with substantial creep and oxidation resistances at high temperatures, often in excess of 70% of their absolute melting temperatures. Additive manufacturing is a suite of technologies that fabricate three-dimensional objects from digital models through an additive process, typically by depositing layer upon layer and joining them in place. Unlike traditional manufacturing processes involving subtraction (e.g., cutting and shearing) and forming (e.g., stamping, bending, and molding), additive manufacturing joins materials together to build products. Articles that are additively manufactured from superalloys are useful in high-temperature environments.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a cross-sectional view of an exemplary metal article formed of a superalloy illustrating a grain structure.

FIG. 2 is a phase diagram of the superalloy.

FIG. 3 is a schematic view of an apparatus for pressure heating a metal article to form the grain structure shown in FIG. 1.

FIG. 4 is a block diagram of an exemplary method of processing the metal article of FIG. 1.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

The phrases “from X to Y” and “between X and Y” each refers to a range of values inclusive of the endpoints (i.e., refers to a range of values that includes both X and Y).

As used herein, the terms “first,” “second,” “third,” and other ordinals are used to distinguish one component from another and are not intended to signify location or importance of the individual components.

In this context, a “metal” refers to a pure metal or a metal alloy (i.e., a compound of pure metals that may or may not include other non-oxygen elements). Examples of metals include aluminum, titanium, copper, and alloys thereof. A “superalloy” or “high-performance alloy” is a metal alloy that has improved properties compared to conventional alloys, such as improved strength, durability, temperature resistance, creep strength, and combinations thereof.

As used herein, the term “nickel or cobalt-containing base metal” refers to a base metal that comprises nickel, cobalt, nickel and cobalt alloys, as well as alloys of nickel, cobalt, or both with other metals such as iron, tungsten, molybdenum, chromium, manganese, titanium, aluminum, tantalum, niobium, zirconium, etc.

A “metal oxide” refers to a compound with a metallic element bonded to an oxygen atom, which includes ceramics such as aluminum oxide (alumina), silicon oxides, rust, among others. The term “metal” as used herein does not include metal oxides or salts that may contain metallic elements (such as sodium chloride, potassium chloride, or magnesium chloride).

A “solvus temperature” is a temperature at which a solid precipitate completely dissolves in a metal alloy.

A “low-reactive environment” is an environment in which oxidizing reactions with elements in a specific alloy are limited to below a specific threshold. The low-reactive environment may be an inert environment (e.g., filled with an inert gas such as argon, gettered to reduce or inhibit oxidation) or an environment with an oxygen concentration below a specific threshold (e.g., less than 1% oxygen).

The present disclosure is generally related to metal articles additively manufactured with superalloys. Typically, metal articles undergo pressure heating at supersolvus temperatures (i.e., temperatures greater than the solvus temperature of precipitates in the metal article), which increases surface variation of the outer surface while recrystallizing the grain structure. The surface variation is then machined away in a polishing or abrading process. Additive manufacturing provides the ability to create geometries unlike those formed by subtractive methods, such as internal features that are difficult to machine and finish. As such, control of near-surface microstructures improves performance of parts where machining and finishing are difficult. In particular, for additively manufactured articles that have such complex geometries and internal features, the surface variation would remain after the supersolvus pressure heating process, reducing performance of the metal article.

By performing a subsolvus pressure heating process followed by a supersolvus heat treatment, surface variation of the metal article is reduced while the grain structure of the superalloy is recrystallized, improving performance of the metal article. In particular, the pressure heating process plastically deforms the metal article and closes pores that are not connected to an outer surface. The supersolvus heat treatment generates a preferred grain size. This sequence of processing is particularly useful for chromia-forming nickel-based superalloys, which lack an alumina scale that would inhibit surface variations from forming in the outer surface during a supersolvus heat treatment.

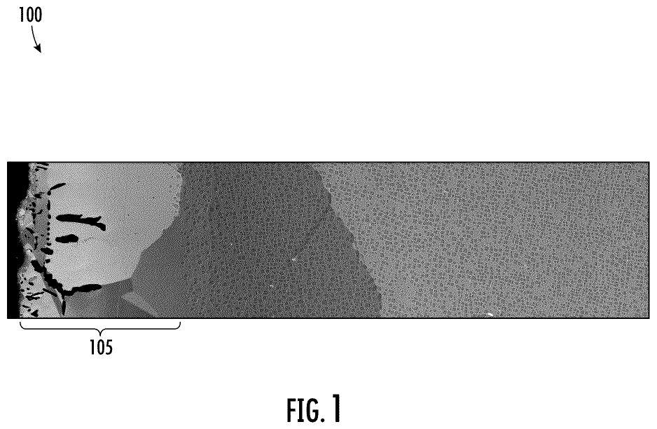

Referring now to the drawings, wherein identical numerals indicate the same elements throughout the figures, FIG. 1 is a photograph of a cross-section of an exemplary metal article 100 showing the grain structure of the metal article 100. As one example, the metal article 100 is an additively manufactured article formed by depositing layers of an alloy material. As described above, the additive manufacturing process that forms the metal article 100 may form complex geometries and internal surfaces that are difficult to smooth by mechanical methods, such as abrasion.

In this form, the metal article 100 includes a metal, such as a nickel-based superalloy, a cobalt-based superalloy, a steel such as stainless steel, a titanium alloy, or other metal commonly used in machine components. In certain embodiments, the article includes a superalloy, meaning a nickel-based superalloy (e.g., a superalloy with a nickel-containing base metal), iron-based superalloy or cobalt-based superalloy (e.g., a superalloy with a cobalt-containing base metal); in particular embodiments, the article includes a nickel-based superalloy. Illustrative nickel and cobalt-based superalloys are designated by the trade names INCONEL (e.g., INCONEL 718), NIMONIC, RENE (e.g., RENE 88, RENE 104 alloys), HAYNES, and UDIMET. For example, an alloy that can be used in making turbine disks, turbine shafts, and other useful components is a nickel-based superalloy available under the trade name INCONEL 718 that has a nominal composition, by weight, of 52.5% nickel, 19% chromium, 3% molybdenum, 3.5% manganese, 0.5% aluminum, 0.45% titanium, 5.1% combined tantalum and niobium, and 0.1% or less carbon, with the balance being iron. As another example, a nickel-based superalloy available under the trade name RENE 88DT has a nominal composition, by weight, of 13% cobalt, 16% chromium, 4% molybdenum, 4% tungsten, 2.1% aluminum, 3.7% titanium, 0.7% niobium, 0.03% carbon, and 0.015% boron.

In particular, the metal article 100 is formed from a metal alloy that lacks a protective metal-oxide layer on the outer surface of the metal article at a maximum temperature of a heat treatment process, such as a chromia-forming nickel-based superalloy (CNS). As an example, certain alloys that contain aluminum create alumina by oxidation of the aluminum when undergoing heat treatment, but even when the alumina is formed, the alumina does not form a contiguous outer layer. Example compositions of such alloys are shown in Table 1 below:

TABLE 1
Compositions for metal article

| | Ni | Cr | Co | Al | W | Ti | Mo | Nb | Ta |
|---|---|---|---|---|---|---|---|---|---|
| Comp. 1 | Bal. | 10-20 | 10-25 | 0-6 | 0 | 0 | 0 | 0 | 0 |
| Comp. 2 | Bal. | 10-20 | 10-25 | 0-6 | 0-6 | 0-6 | 0-10 | 0-3 | 0-8 |
| Comp. 3 | Bal. | 12-17 | 11-20 | 1.5-4 | 2-6 | 2-4 | 2-6 | 1-3 | 1-6 |

In Table 1, the numbers indicate composition by weight percent, and “Bal.” refers to the remaining balance of the weight being nickel. For example, Alloy 1 has a nominal composition, by weight, of 10-20% Cr, 10-25% Co, 0-6% Al, and the remainder Ni.

The metal article 100 has reduced surface variation 105 compared to articles formed with different heat treatments or with other alloys that are not alumina-forming. In this context, “surface variation” 105 is a region starting at an outer surface of the metal article 100 in which the grain structure of the metal varies. Specifically, the surface variation 105 of the metal article 100 of FIG. 1 is below 30 microns, which means that, beyond a depth of 30 microns from the outer surface, the grain structure of the metal article 100 is substantially consistent. The reduced surface variation 105 provides improved mechanical performance of the metal article 100, such as tensile strength, fatigue capability, creep capability, and the like. It will be appreciated that the metal article 100 of the present disclosure may have a surface variation below 125 microns, such as below 30 microns as shown in FIG. 1.

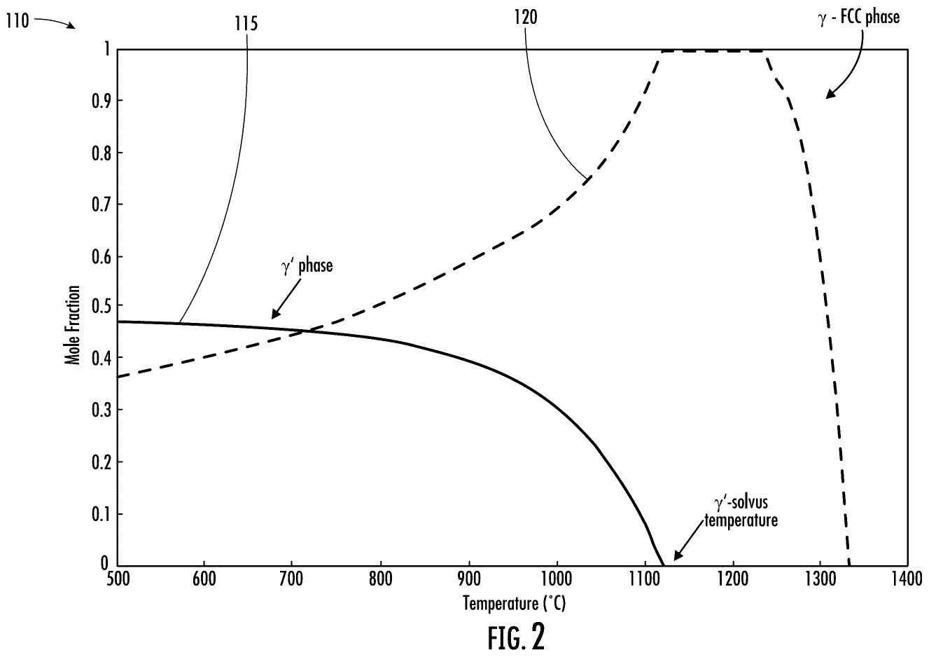

Now referring to FIG. 2, a phase diagram 110 of a chromia-forming nickel-based superalloy is shown. The phase diagram 110 shows a respective amount of different phases of the CNS at specific temperatures. The vertical axis shows the amount of the phase, measured in mole fraction. The horizontal axis shows temperature, in degrees Fahrenheit.

The phase diagram 110 in particular shows the amounts of two phases of the CNS: gamma prime phase (γ′) (shown by the line 115) and a gamma face-centered cubic (disordered γ-FCC) phase (shown by the line 120). Gamma prime is a precipitate that grows in a metal article 100 formed of the CNS. Gamma prime is an L1₂ (ordered FCC) crystal structure of composition Ni₃(Al, Ti). Gamma prime precipitates may also include several “gamma prime forming elements” including tantalum, niobium, and hafnium. FCC is an arrangement of the atoms of the CNS. As the temperature of the CNS increases, the mole fraction of γ′ decreases and the mole fraction of FCC increases. That is, the γ′ precipitates dissolve as the temperature increases. A temperature at which all of the γ′ dissolves (i.e., the mole fraction of γ′ is zero) is a “solvus” temperature, shown in FIG. 2 as the line 115 having a value of 0. Temperatures above the solvus temperature are “supersolvus,” and temperatures below the solvus temperature are “subsolvus.”

The metal article 100 can be heated to supersolvus and subsolvus temperatures during specific heat treatments. As an example, the metal article 100 can be heated in a heat treatment to a supersolvus temperature in a low-reactive environment (such a vacuum or gettered environment) to form a specific grain structure for the metal article 100. Specifically, heating the metal article 100 to the supersolvus temperature in the low-reactive environment causes grain boundaries and dislocations to reform into a recrystallized structure, improving microstructure integrity of the metal article without introducing additional surface variation 105. That is, in the low-reactive environment, fewer oxidation reactions occur, which allow for growth of γ′ precipitates from elements that would otherwise be consumed in the oxidation reactions.

Additionally, as described below, the metal article 100 can be heated to a subsolvus temperature to reduce the surface variation 105. The solvus temperature of the CNS alloy of FIG. 2 is typically from 1120° C.-1160° C. (2050° F.-2120° F.), and the metal article can be heated to a subsolvus temperature that is from about 30-120 degrees Celsius below the solvus temperature, such as from 1000° C. to 1130° C. (1832° F. to 2065° F.), preferably in a range from 50-100 degrees Celsius below the solvus temperature. In particular, the subsolvus temperature can be determined to reduce diffusion of aluminum, titanium, or other γ′-forming elements to the outer surface of the metal article 100. The metal article 100 may undergo another supersolvus heat treatment, as described above, following the subsolvus heat treatment. In such a form where two supersolvus heat treatments are performed, the respective temperature for each of the supersolvus heat treatments may be a same temperature or a different temperature. The subsolvus heat treatment may inhibit the surface variation 105 from growing beyond a specified depth. The specified depth may be less than 125 microns, such as less than 30 microns.

After heating the metal article 100 at the supersolvus temperature, the metal article 100 may undergo a cooling process, such as quenching. That is, the metal article 100 is actively cooled to fix the recrystallized grain structure and/or the γ′ precipitate structure formed by the supersolvus heat treatment and subsequent cooling. Alternatively, the active cooling process may be omitted, and the metal article 100 may be cooled in ambient room temperatures that form the γ′ precipitate structure, such as 20-25° C. The metal article 100 may be actively cooled at a specific cooling rate, such as at least 45 degrees Celsius per minute (C/min), at least 25° C./min, or at least 10° C./min.

Following the heat treatments, the metal article 100 may be aged at a subsolvus temperature to further precipitate and grow a preferred size distribution and amount of γ′. In particular, the distribution of γ′ provides specific material properties for the metal article 100, such as maintaining the strength and fatigue resistance of the metal article at high temperatures. That is, γ′ in specific amounts and sizes allows the metal article to gain the beneficial properties of superalloys. The subsolvus temperature may be the subsolvus temperature described above, e.g., from 1000° C. to 1130° C. (1832° F. to 2065° F.), or a lower temperature, such as 600° C.

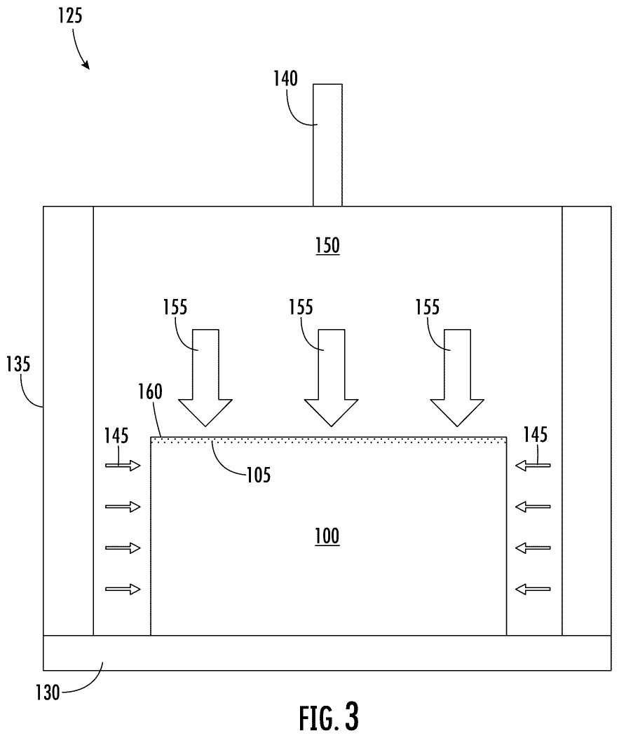

With reference to FIG. 3, a schematic view of an example metal article 100 undergoing a pressure heating process is shown. In this context, a “pressure heating” process is process by which pressure and heat are applied to the metal article 100 to cause a change to the material properties of the metal article. One such pressure heating process is a hot isostatic pressing process, and FIG. 3 illustrates an apparatus 125 for the hot isostatic pressing process.

The apparatus 125 includes a platform 130, a heater 135, and a pressurizer 140. The metal article 100 is placed on the platform 130 and heated by the heater 135, indicated by arrows 145. The apparatus 125 defines a sealed chamber 150 in which a gas is provided to a specific pressure, indicated by arrows 155, by the pressurizer 140. Specifically, the gas may be an inert gas, such as argon, such that the metal article 100 is in an inert environment in the sealed chamber 150. Because the pressure and temperature remain relatively constant during the pressure heating process, the process is an isostatic method of hot pressing the metal article 100. As an example, the pressure in the sealed chamber may be in a range from 100 megapascals (MPa) to 200 MPa.

In particular, the apparatus 125 can pressure heat the metal article 100 at a subsolvus temperature of a γ′ to inhibit growth of surface variations 105 of an outer surface 160 of the metal article 100. That is, at the subsolvus temperature, the pressure and heat plastically deform the metal article 100, closing pores that are not connected with the outer surface 160. With the reduced surface variation 105, the metal article 100 can undergo additional heat treatment processes to attain a preferred grain and precipitate structure, as shown in FIG. 1. As described above, the metal article 100 may undergo a supersolvus heat treatment before the subsolvus pressure heating process, after the subsolvus pressure heating process, or both.

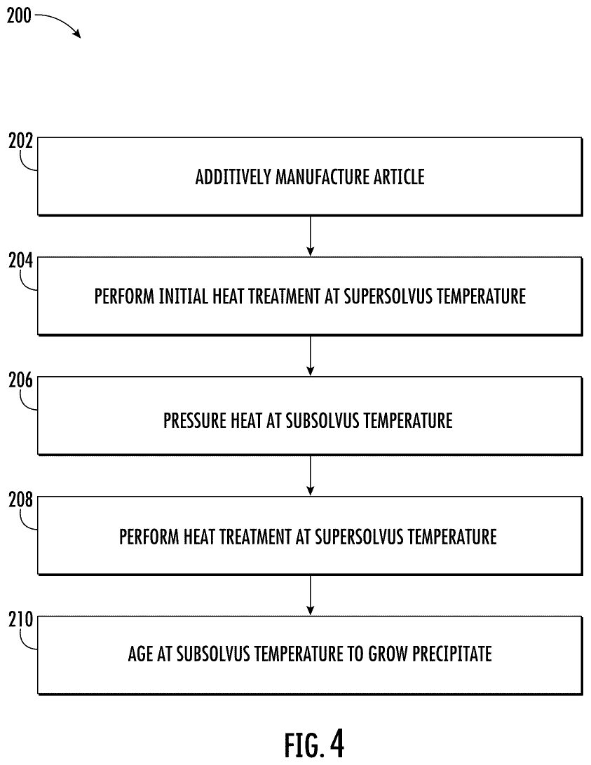

Referring now to FIG. 4, a flow diagram of a method 200 of processing a metal article in accordance with an exemplary aspect of the present disclosure is provided. The method 200 may be utilized to process the exemplary metal article 100 formed of a superalloy described above with reference to FIGS. 1-3.

As is depicted, the method 200 includes at (202) additively manufacturing the metal article. As described above, the metal article may be formed in an additive manufacturing process from a metal alloy, such as a chromia-forming nickel-based superalloy (CNS).

The method 200 includes at (204) performing an initial heat treatment at a supersolvus temperature to recrystallize the grain structure of the metal article. As described above, the metal article can be heated in a low-reactive environment at a temperature above a solvus temperature for a precipitate, such as γ′, as shown in FIG. 2. The heat treatment at the supersolvus temperature sets a recrystallized grain structure for the CNS.

The method 200 includes at (206) pressure heating the metal article at a subsolvus temperature. The pressure heating may occur as a hot isostatic pressing process in an apparatus as shown in FIG. 3. During the pressure heating, the metal article may plastically deform, closing pores while limiting or inhibiting surface microstructure variations. In particular, the pressure heating may be performed such that the surface variation of the metal article is less than 125 microns, such as less than 30 microns. The pressure heating may occur in an inert environment, such as an argon environment. It will be appreciated that the metal article may undergo pressure heating without an initial supersolvus heat treatment. That is, the method 200 may progress from step (202) directed to step (206), omitting step (204).

The method 200 includes at (208) performing a heat treatment at a supersolvus temperature in a low-reactive environment. Heating the metal article at the supersolvus temperature causes the grain boundaries and dislocations to reform into a recrystallized structure, improving microstructure integrity of the metal article. The supersolvus temperature of (208) may be a same temperature as the supersolvus temperature of (204). Alternatively, the supersolvus temperature of (208) may be a different temperature than the supersolvus temperature of (204). It will be appreciated that, when the step (204) is omitted, the sole supersolvus heat treatment of step (208) recrystallizes the grain structure of the metal article.

The method 200 includes at (210) aging the metal article at a subsolvus temperature to grow existing precipitates and nucleate and grow additional precipitates. More specifically, at the subsolvus temperature, precipitates such as γ′ may form in the metal article. Controlling the growth of the precipitates allows for specific material properties of the metal article.

Further aspects are provided by the subject matter of the following clauses:

A method for processing a metal article includes pressure heating the metal article at a first temperature that is below a solvus temperature of a precipitate to reduce growth of surface variation of an outer surface of the metal article and heating the metal article at a second temperature that is above the solvus temperature of the precipitate to form a recrystallized grain structure of the metal article.

The method of any of the preceding clauses, wherein the metal article is a metal alloy lacking a protective metal-oxide layer on the outer surface of the metal article at a maximum heat treatment temperature.

The method of any of the preceding clauses, wherein the metal alloy is a chromia-forming nickel-based superalloy.

The method of any of the preceding clauses, wherein the metal alloy includes 10-20% Cr, 10-25% Co, and 0-6% Al.

The method of any of the preceding clauses, wherein the metal alloy further includes 0-6% W, 0-6% Ti, 0-10% Mo, 0-3% Nb, and 0-8% Ta.

The method of any of the preceding clauses, wherein the metal alloy further includes 12-17% Cr, 11-20% Co, 1.5-4% Al, 2-6% W, 2-4% Ti, 2-6% Mo, 1-3% Nb, and 1-6% Ta.

The method of any of the preceding clauses, further including, prior to pressure heating the metal article, heating the metal article at a third temperature that is above the solvus temperature of the precipitate.

The method of any of the preceding clauses, wherein heating the metal article at the third temperature or heating the metal article at the second temperature further includes heating the metal article in a low-reactive environment.

The method of any of the preceding clauses, wherein the low-reactive environment is an inert environment including an inert gas.

The method of any of the preceding clauses, wherein the low-reactive environment is a vacuum.

The method of any of the preceding clauses, wherein the low-reactive environment is a gettered environment.

The method of any of the preceding clauses, wherein the low-reactive environment is environment with an oxygen concentration below 1%.

The method of any of the preceding clauses, wherein the metal article is an additively manufactured article.

The method of any of the preceding clauses, wherein pressure heating the metal article includes pressure heating the metal article in a hot isostatic pressing process.

The method any of the preceding clauses, wherein the hot isostatic pressing process includes applying a pressure to the metal article in a range from 100 to 200 megapascals.

The method of any of the preceding clauses, further including cooling the metal article at a rate of at least 10 degrees Celsius per minute after heating the metal article at the second temperature to control growth of the precipitate.

The method of any of the preceding clauses, wherein the rate of cooling is at least 25 degrees Celsius per minute.

The method of any of the preceding clauses, wherein the rate of cooling is at least 45 degrees Celsius per minute.

The method of any of the preceding clauses, wherein the precipitate is a gamma prime precipitate.

The method of any of the preceding clauses, wherein the gamma prime precipitate includes nickel and one of aluminum or titanium.

The method of any of the preceding clauses, wherein the gamma prime precipitate includes at least one of tantalum, niobium or hafnium.

The method of any of the preceding clauses, wherein the surface variation of the metal article following heating the metal article at the second temperature is less than 125 microns from the outer surface.

The method of any of the preceding clauses, wherein the surface variation is less than 30 microns from the outer surface.

The method of any of the preceding clauses, wherein the first temperature is a temperature from 30 to 120 degrees Celsius below the solvus temperature.

The method of any of the preceding clauses, wherein the first temperature is a temperature from 50 to 100 degrees Celsius below the solvus temperature

The method of any of the preceding clauses, further including aging the metal article at a third temperature that is below the solvus temperature of the precipitate.

The method of any of the preceding clauses, wherein the first temperature is a temperature in a range from 1000-1130 degrees Celsius.

The method of any of the preceding clauses, wherein pressure heating the metal article further includes closing one or more pores that are not connected with the outer surface of the metal article.

The method of any of the preceding clauses, wherein pressure heating the metal article further includes plastically deforming the metal article.

A metal article processed according to the method of any of the preceding clauses.

The metal article of any of the preceding clauses, wherein the metal article is a metal alloy that does not form a protective metal-oxide layer on the outer surface of the metal article at a maximum heat treatment temperature, wherein the metal alloy includes 10-20% Cr, 10-25% Co, and 0-6% Al.

The metal article of any of the preceding clauses, wherein the metal alloy further includes 0-6% W, 0-6% Ti, 0-10% Mo, 0-3% Nb, and 0-8% Ta.

A method for forming a metal article includes additively manufacturing the metal article from a chromia-forming nickel-based superalloy, heating the metal article at a first temperature that is above a solvus temperature of a gamma prime precipitate to form a recrystallized grain structure of the metal article, pressure heating the metal article at a second temperature that is below the solvus temperature of the gamma prime precipitate to reduce growth of surface variation of an outer surface of the metal article, heating the metal article at a third temperature that is above the solvus temperature of the gamma prime precipitate to re-form at least a portion of the recrystallized grain structure of the metal article, and aging the metal article at a fourth temperature that is below the solvus temperature of the gamma prime precipitate.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for processing a metal article, the method comprising:
pressure heating the metal article at a first temperature that is below a solvus temperature of a precipitate to reduce growth of a surface variation of an outer surface of the metal article; and
heating the metal article at a second temperature that is above the solvus temperature of the precipitate to form a recrystallized grain structure of the metal article.

2. The method of claim 1, wherein the metal article is a metal alloy lacking a protective metal-oxide layer on the outer surface of the metal article at a maximum heat treatment temperature.

3. The method of claim 2, wherein the metal alloy is a chromia-forming nickel-based superalloy.

4. The method of claim 3, wherein the metal alloy comprises 10-20% Cr, 10-25% Co, and 0-6% Al.

5. The method of claim 4, wherein the metal alloy further comprises 0-6% W, 0-6% Ti, 0-10% Mo, 0-3% Nb, and 0-8% Ta.

6. The method of claim 1, further comprising, prior to pressure heating the metal article, heating the metal article at a third temperature that is above the solvus temperature of the precipitate.

7. The method of claim 6, wherein heating the metal article at the third temperature or heating the metal article at the second temperature further comprises heating the metal article in a low-reactive environment.

8. The method of claim 1, wherein the metal article is an additively manufactured article.

9. The method of claim 1, wherein pressure heating the metal article includes pressure heating the metal article in a hot isostatic pressing process.

10. The method of claim 1, further comprising cooling the metal article at a rate of at least 10 degrees Celsius per minute after heating the metal article at the second temperature to control growth of the precipitate.

11. The method of claim 10, wherein the rate of cooling is at least 25 degrees Celsius per minute.

12. The method of claim 1, wherein the precipitate is a gamma prime precipitate.

13. The method of claim 1, wherein the surface variation of the metal article following heating the metal article at the second temperature is less than 125 microns from the outer surface.

14. The method of claim 13, wherein the surface variation is less than 30 microns from the outer surface.

15. The method of claim 1, wherein the first temperature is a temperature from 30 to 120 degrees Celsius below the solvus temperature.

16. The method of claim 1, further comprising aging the metal article at a third temperature that is below the solvus temperature of the precipitate.

17. A metal article processed according to the method of claim 1.

18. The metal article of claim 17, wherein the metal article is a metal alloy that does not form a protective metal-oxide layer on the outer surface of the metal article at a maximum heat treatment temperature, wherein the metal alloy comprises 10-20% Cr, 10-25% Co, and 0-6% Al.

19. The metal article of claim 18, wherein the metal alloy further comprises 0-6% W, 0-6% Ti, 0-10% Mo, 0-3% Nb, and 0-8% Ta.

20. A method for forming a metal article, the method comprising:
additively manufacturing the metal article from a chromia-forming nickel-based superalloy;
heating the metal article at a first temperature that is above a solvus temperature of a gamma prime precipitate to form a recrystallized grain structure of the metal article;
pressure heating the metal article at a second temperature that is below the solvus temperature of the gamma prime precipitate to reduce growth of a surface variation of an outer surface of the metal article;
heating the metal article at a third temperature that is above the solvus temperature of the gamma prime precipitate to re-form at least a portion of the recrystallized grain structure of the metal article; and
aging the metal article at a fourth temperature that is below the solvus temperature of the gamma prime precipitate.
